(19) United States
(12) Patent Application Publication
(10) Pub. No.: US 2022/0405769 A1
(43) Pub. Date: Dec. 22, 2022

(54) Test Time Estimation Suggestion Providing System Based On Product Configuration Information And Method Thereof

(71) Applicants: Inventec (Pudong) Technology Corporation, Shanghai (CN); Inventec Corporation, Taipei City (TW)

(72) Inventor: Jian-Ming Li, Shanghai (CN)

(21) Appl. No.: 17/357,474

(22) Filed: Jun. 24, 2021

(30) Foreign Application Priority Data
Jun. 18, 2021 (CN) 202110677374.7

(51) Int. Cl. G06Q 30/00; G06F 16/28; G06F 16/245; G06N 3/08

(52) U.S. Cl. CPC G06Q 30/018; G06F 16/285; G06F 16/245; G06N 3/08

(57) ABSTRACT

A test time estimation suggestion providing system based on product configuration information and a method thereof are disclosed. In the system, a database, a product configuration word database and a product embedding vector database are established, new product configuration information is analyzed to obtain analysis words, one-hots corresponding to the analysis words are queried and imported into a trained word2vec neural network model to calculate word embedding vectors, and all word embedding vectors are added to obtain a new product embedding vector, which is then compared with the existing product embedding vectors to find the product embedding vector most approximate to the new product embedding vector, and a model test time and a family test time of the existing product corresponding to the found product embedding vector are used as an estimation suggestion for a model test time and a family test time of the new product.

### BACKGROUND OF THE INVENTION

### 1. Cross-Reference to Related Application

This application claims the benefit of Chinese Application Serial No. 202110677374.7, filed Jun. 18, 2021, which is hereby incorporated herein by reference in its entirety.

### 2. Field of the Invention

The present invention is related to an estimation suggestion system and a method thereof. More particularly, the present invention is related to a test time estimation suggestion providing system based on product configuration information, and a method thereof: the test time estimation suggestion providing system performs neural network calculation based on product configuration information to provide a test time estimation suggestion.

### 3. Description of the Related Art

At present, in production processes of manufacturing companies, product testing is an indispensable production stage for checking and ensuring product quality. The test time estimation in the testing stage is important for production scheduling and equipment management, and is also a significant factor for providing transparent production.

However, there is no clear specification for the configuration information of the products, the manufacturing companies have obviously different product configuration information for the same products, for example, the different product configuration information can include different names, different expressions of parameters, or different amounts of information; in this situation, the existing statistical method is unable to provide a sufficient use rate for the product configuration information, so there is not an effective method to use the product configuration information in estimation of the product test time for production of new product.

Therefore, what is needed is to develop an improved technical solution to solve the problem of inaccurate product test time estimation.

### SUMMARY OF THE INVENTION

The objective of the present invention is to disclose a test time estimation suggestion providing system based on product configuration information and a method thereof, so as to solve the conventional technology problem of inaccurate product test time estimation.

In order to achieve the objective, the present invention provides a test time estimation suggestion providing system based on product configuration information, and the test time estimation suggestion providing system is adapted to an analysis calculation device and includes a database, a product configuration word database, a product embedding vector database, a receiving module, a neural network module and a time estimation module. The database is configured to store an exist product family, an exist product model, a model test time and a family test time of an existing product. The product configuration word database is configured to store product configuration words and one-hots. The product configuration words are generated by analyzing product configuration information of the existing product. The product embedding vector database is configured to store a product embedding vector of the existing product, and perform hierarchical clustering calculation on the product embedding vector to generate a hierarchical clustering tree with at least three layers. The receiving module is configured to receive new product configuration information of a new product. The neural network module is configured to perform word analysis on the new product configuration information to obtain a plurality of analysis words, query the product configuration word database for the one-hots corresponding to the plurality of analysis words, import the one-hots corresponding to the plurality of analysis words into a trained word2vec neural network model in sequential order to calculate a plurality of word embedding vectors, and add all of the plurality of word embedding vectors, so as to obtain a new product embedding vector of the new product configuration information. The time estimation module is configured to compare the new product embedding vector with the hierarchical clustering tree to obtain a clustering layer, compare the new product embedding vector with the clustering layer to obtain the product embedding vector most approximate to the new product embedding vector, and use the model test time and the family test time of the existing product corresponding to the product embedding vector as an estimation suggestion for the model test time and the family test time of the new product.

According to an embodiment, the present invention provides a test time estimation suggestion providing method based on product configuration information, and the test time estimation suggestion providing method is adapted to an analysis calculation device and includes steps of: using the analysis calculation device to establish a database in advance to store an exist product family, an exist product model, a model test time and a family test time of an existing product; using the analysis calculation device to establish a product configuration word database in advance to store product configuration words and one-hots, w % herein the product configuration words are obtained by analyzing product configuration information of the existing product; using the analysis calculation device to establish a product embedding vector database in advance to store a product embedding vector of the existing product, and using the analysis calculation device to perform hierarchical clustering calculation on the product embedding vectors to generate a hierarchical clustering tree with at least three layers; using the analysis calculation device to receive new product configuration information of a new product; using the analysis calculation device to perform word analysis on the new product configuration information to obtain a plurality of analysis words; using the analysis calculation device to query product configuration word database for the one-hot corresponding to the plurality of analysis words; using the analysis calculation device to import the one-hots corresponding to the plurality of analysis words into the trained word2vec neural network model in sequential order, to calculate a plurality of word embedding vectors, and add of the word embedding vectors to generate a new product embedding vector of the new product configuration information; using the analysis calculation device to compare the new product embedding vector with the hierarchical clustering tree to obtain a clustering layer; using the analysis calculation device to compare the new product embedding vector with the clustering layer to find the product embedding vector most approximate to the new product embedding vector; using the analysis calculation device to set the model test time and the family test time of the existing product corresponding to the found product embedding vector as an estimation suggestion for a model test time and a family test time of the new product.

According to the above-mentioned system and method of the present invention, the difference between the conventional technology and the present invention is that, in the present invention, the database, the product configuration word database and the product embedding vector database are established, the new product configuration information is analyzed to obtain the analysis words, one-hots corresponding to the analysis words are queried and imported into the trained word2vec neural network model in sequential order to calculate the word embedding vectors, and all of the word embedding vectors are added to obtain the new product embedding vector, and the new product embedding vector is compared with the existing product embedding vectors to find the product embedding vector most approximate to the new product embedding vector, and the model test time and the family test time of the existing product corresponding to the found product embedding vector are used as the estimation suggestion for the model test time and the family test time of the new product.

According to the above-mentioned technical, the present invention is able to achieve the technical effect of providing the test time estimation suggestion based on the product configuration information.

### BRIEF DESCRIPTION OF THE DRAWINGS

The structure, operating principle and effects of the present invention will be described in detail by way of various embodiments which are illustrated in the accompanying drawings.

FIG. 1 is a system block diagram of a test time estimation suggestion providing system based on product configuration information, according to the present invention.

FIG. 2 is a schematic diagram of a database of a test time estimation suggestion providing system, according to the present invention.

FIG. 3 is a schematic diagram of a product configuration word database of a test time estimation suggestion providing system, according to the present invention.

FIG. 4 is a schematic diagram of a product embedding vector database of a test time estimation suggestion providing system, according to the present invention.

FIGS. 5A and 5B are flowcharts of a test time estimation suggestion providing method based on product configuration information, according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

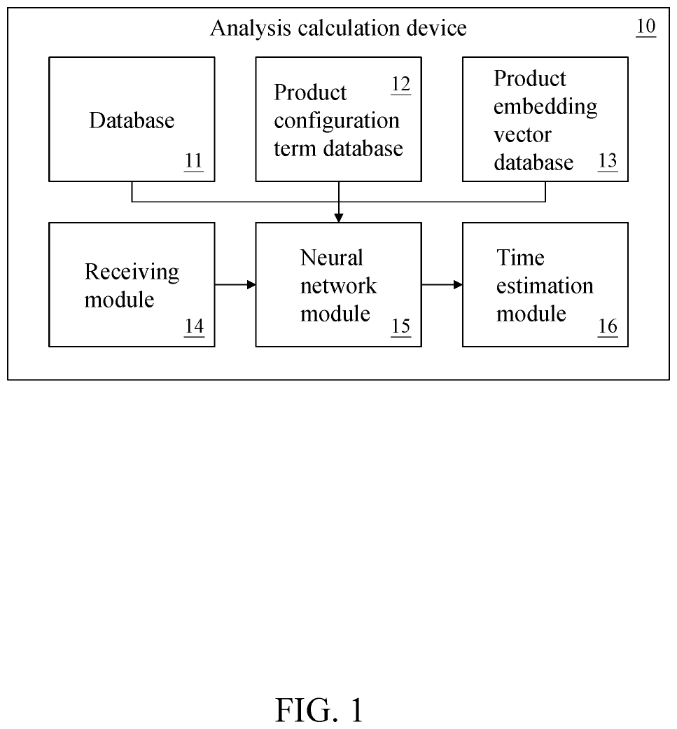

The test time estimation suggestion providing system of the present invention will be descried in the following paragraphs. Please refer to FIG. 1, which is a system block diagram of a test time estimation suggestion providing system based on product configuration information, according to the present invention.

As shown in FIG. 1, the test time estimation suggestion providing system of the present invention is adapted to an analysis calculation device 10 and includes a database 11, a product configuration word database 12, a product embedding vector database 13, a receiving module 14, a neural network module 15 and a time estimation module 16. In an embodiment, the analysis calculation device 10 can be, for example, a general computer, a notebook computer or a server, however, these examples are merely for exemplary illustration, and the application field of the present invention is not limited to these examples.

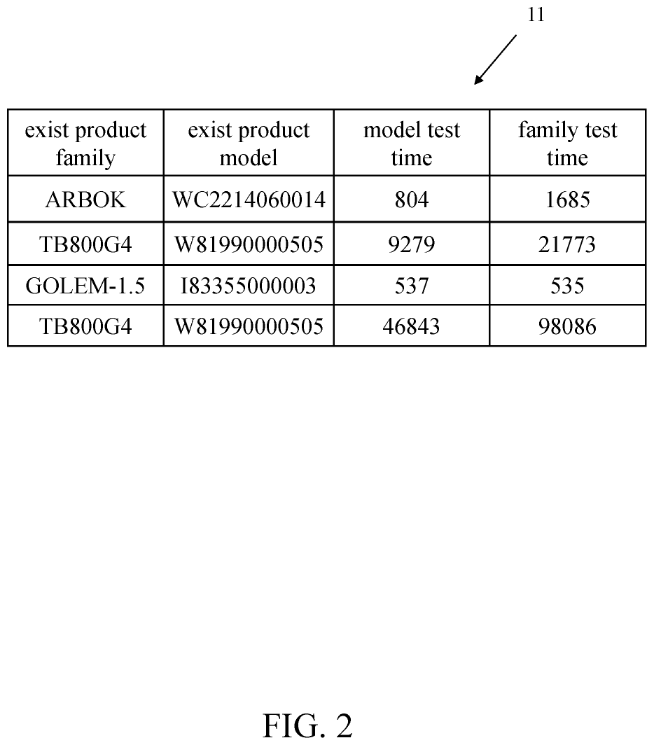

The database 11 stores an exist product family, an exist product model, a model test time and a family test time of an existing product. In order to generate the exist product family, the exist product model, the model test time and the family test time of the existing product stored in the database 11, the analysis calculation device 10 eliminates outlier data in historical data of the existing product according to box plot, and performs statistics analysis on the historical data, which excludes the outlier data, of existing product, and then calculates an average of the model test times of the exist product models and an average of the family test times of the exist product model as the model test time and the family test time, respectively. The database 11 is shown in FIG. 2, which is a schematic diagram of the database of the test time estimation suggestion providing system, according to the present invention.

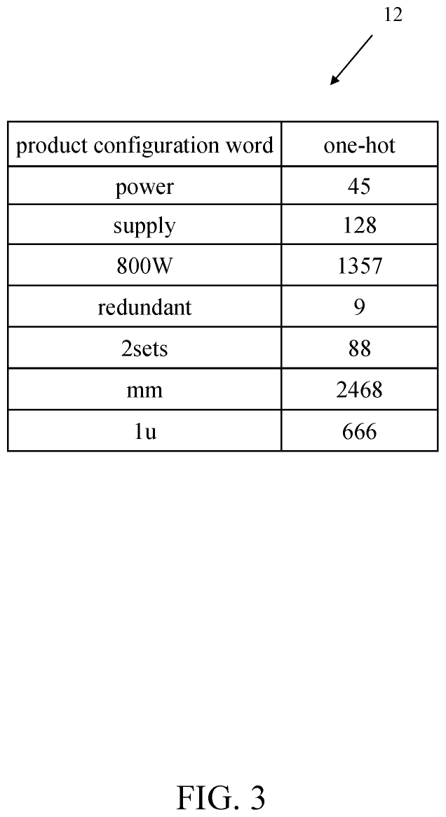

The product configuration word database 12 stores product configuration words and one-hots, and product configuration words are obtained by analyzing the product configuration information of the existing product. In general, the product configuration information of different product is formed by a series of multiple words with different lengths; particularly, the product configuration information may include, for example, a term “power supply 800 W redundant 2 sets millimeter 1 u”, the analysis calculation device 10 performs word analysis on the term “power supply 800 W redundant 2 sets mm 1 u” to generate the product configuration words including “power”, “supply”. “800 W”. “redundant”, “2 sets”, “mm” and “1 u”, and the analysis calculation device 10 then sets unique and non-repetitive one-hots including “45”, “128”, “1357”, “9”, “88”. “2468” and “666” to the words “power”, “supply”, “800 W”, “redundant”, “2 sets”, “mm” and “1 u”, respectively; however, these examples are merely for exemplary illustration, and the application field of the present invention is not limited to these examples. The product configuration word database 12 is shown in FIG. 3, which is a schematic diagram of the product configuration word database of the test time estimation suggestion providing system, according to the present invention. It should be noted that the product configuration word database 12 storing the exist product model shown in FIG. 3 is taken as a schematic example, and the product configuration word database 12 can be designed to store data of the exist product family, or store data of the exist product model and the exist product family.

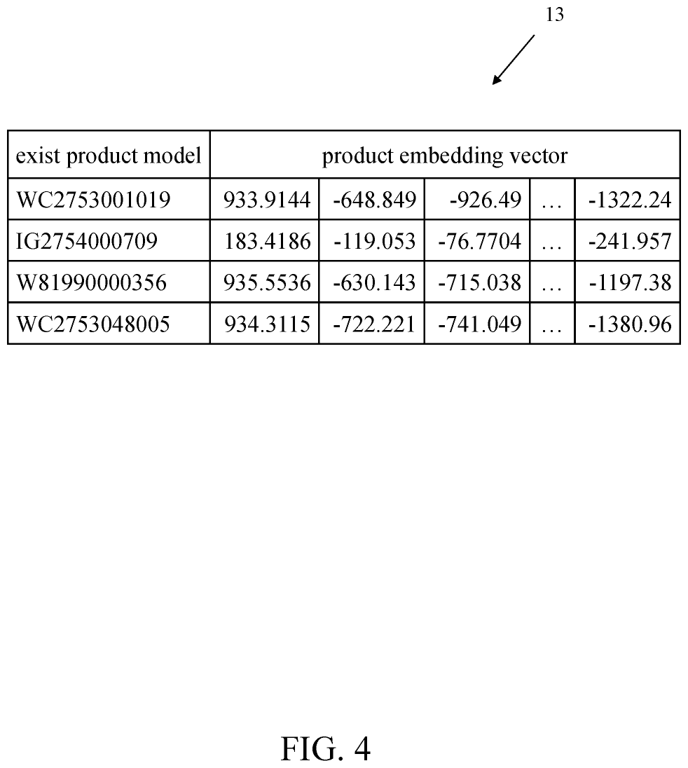

The product embedding vector database 13 stores product embedding vectors of the existing products, and performs hierarchical clustering calculation on the product embedding vectors to generate a hierarchical clustering tree with at least three layers: the analysis calculation device 10 then performs word analysis on the product configuration information through the neural network module 15, to obtain a set of center words and at least two environment words, query the product configuration word database 12 for the one-hots corresponding to the set of center words and the at least two environment words, and then train a word2vec neural network model with the one-hots which correspond to the at least two environment words and are used as input for the word2vec neural network model, and with the one-hots which corresponds to the set of center words and are used as labels for the word2vec neural network model, for many times, so as to obtain a plurality of training embedding vectors, and all of the plurality of training embedding vectors are added up to obtain a product embedding vector of the product configuration information. The manner and process of training the word2vec neural network model are well known in prior art, so the detailed description is not repeated herein. The product embedding vector database 13 is shown in FIG. 4, which is a schematic diagram of a product embedding vector database of a test time estimation suggestion providing system, according to the present invention. In an embodiment, the dimension value of the product embedding vector is set as 300, but this example is merely for exemplary illustration, and the application field of the present invention is not limited to this example.

It should be noted that the word analysis performed on the product configuration information to obtain the set of center words and the at least two environment words can be implemented by selecting a set number of words in sequential order, and using a middle part of the selected words as the set of center words and using the remaining words of the selected words as the at least two environment words. In an embodiment, the set number can be odd.

Particularly, in a condition that the product configuration information is “power supply 800 W redundant 2 sets mm 1 u” and the selection number is set as 5, the selected words are “power”, “supply”, “800 W”, “redundant” and “2 sets” in sequential order, so the center word is “800 W” and the environment words are “power”, “supply”, “redundant”, “redundant” and “2 sets”; in next selection, the re-selected words are “supply”, “800 W”, “redundant”, “2 sets” and “mm” in sequential order, so the center word is “redundant” and the environment words are “supply”, “800 W”, “2 sets” and “mm”; however, these examples are merely for exemplary illustration, and the application field of the present invention is not limited to these examples.

When the receiving module 14 receives new product configuration information of anew product, the neural network module 15 performs word analysis on the new product configuration information to obtain a plurality of analysis words, and then queries the product configuration word database 12 for one-hots corresponding to the plurality of analysis words, and imports the one-hots corresponding to the plurality of analysis words into the trained word2vec neural network model in sequential order, so as to calculate a plurality of word embedding vectors, and add all of the plurality calculated word embedding vector to obtain a new product embedding vector of the new product configuration information. The calculation operation of the word2vec neural network model is well known in prior art, so the detailed description is not repeated herein.

It should be noted that when the new product configuration information received by the receiving module 14 has at least one word different from the existing product configuration words stored in the product configuration word database 12, the analysis calculation device 10 can establish a product configuration word for the word different from the existing product configuration words, and set a unique and non-repetitive one-hot to the product configuration word, and then update the product configuration word database 12.

The time estimation module 16 compares the new product embedding vector with the hierarchical clustering tree to obtain a clustering layer, and then compares the new product embedding vector with the clustering layer to obtain the product embedding vector most approximate to the new product embedding vector, and use the model test time and the family test time of the existing product corresponding to the obtained product embedding vector as an estimation suggestion for the model test time and the family test time of the new product.

Furthermore, the time estimation module 16 can compare the new product embedding vector with the hierarchical clustering tree to obtain the clustering layer, and select the product embedding vector in the clustering layer based on a data selection threshold, and then use the model test time and the family test time of the existing product corresponding to the selected product embedding vector as the estimation suggestion for the model test time and the family test time of the new product. The data selection threshold can be set in the analysis calculation device 10 in advance, or can be input through an external input manner; however, these examples are merely for exemplary illustration, and the application field of the present invention is not limited to these examples.

Particularly, in a condition that the amount of the product embedding vectors in the clustering layer is 10 and the data selection threshold is set as 5, the time estimation module 16 selects five product embedding vectors most approximate to the new product embedding vector from the product embedding vectors in the clustering layer, and use the model test times and the family test times of the existing products corresponding to the selected product embedding vectors as the estimation suggestion for the model test time and the family test time of the new product.

It should be noted that the analysis calculation device 10 can periodically update the product configuration word database 12; when the product configuration word database 12 is updated, the analysis calculation device 10 can re-train the word2vec neural network model through the neural network module 15 to calculate the product embedding vector of the product configuration information and perform hierarchical clustering calculation on the product embedding vectors, so as to update the product embedding vector database 13. Periodically updating the product configuration word database 12 and the product embedding vector database 13 can ensure the timeliness and accuracy of the estimation suggestion of the test time provided by the time estimation module 16.

The main concept of the present invention is that configuration semantics of the product configuration information can be formed according to big data analysis, the deep learning model of neural network can be used to learn the configuration semantics, and the embed layers of the deep learning model can be used to convert the product configuration information into a unique embedding vector, so that approximate comparison can be performed on the product configuration information of the products based on the embedding vectors, and the embedding vectors can be used to establish the hierarchical clustering tree through hierarchical clustering calculation, and the hierarchical clustering tree can effectively improve approximate comparison speed for the product configuration information, thereby improving the accuracy of estimation suggestion for the model test time and family test time of the new product.

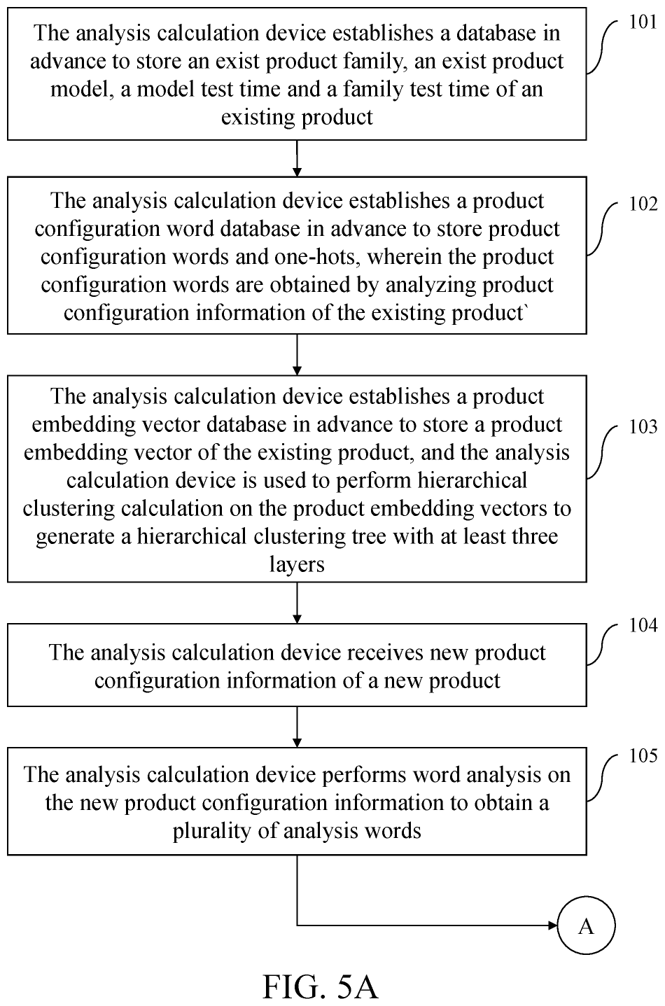

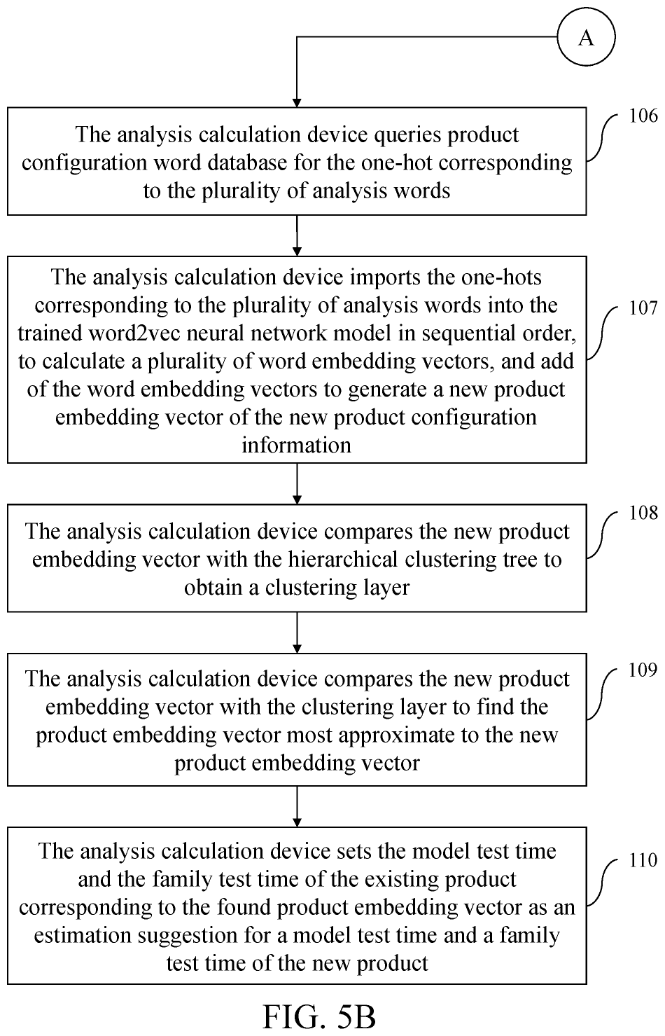

The first implementation of system and method of the present invention will be described according to a first embodiment in reference with FIGS. 5A and 5B. FIGS. 5A and 5B are flowcharts of a test time estimation suggestion providing method based on product configuration information, according to the present invention.

As shown in FIGS. 5A and 5B, the test time estimation suggestion providing method of the present invention includes steps 101 to 110.

First of all, in a step 101, an analysis calculation device establishes a database in advance to store an exist product family, an exist product model, a model test time and a family test time of an existing product. In a step 102, the analysis calculation device establishes a product configuration word database in advance to store product configuration words and one-hots, wherein the product configuration words are obtained by analyzing product configuration information of the existing product. In a step 103, the analysis calculation device establishes a product embedding vector database in advance to store a product embedding vector of the existing product, and the analysis calculation device is used to perform hierarchical clustering calculation on the product embedding vectors to generate a hierarchical clustering tree with at least three layers. In a step 104, the analysis calculation device receives new product configuration information of a new product. In a step 105, the analysis calculation device performs word analysis on the new product configuration information to obtain a plurality of analysis words. In a step 106, the analysis calculation device queries product configuration word database for the one-hot corresponding to the plurality of analysis words. In a step 107, the analysis calculation device imports the one-hots corresponding to the plurality of analysis words into the trained word2vec neural network model in sequential order, to calculate a plurality of word embedding vectors, and add of the word embedding vectors to generate a new product embedding vector of the new product configuration information. In a step 108, the analysis calculation device compares the new product embedding vector with the hierarchical clustering tree to obtain a clustering layer. In a step 109, the analysis calculation device compares the new product embedding vector with the clustering layer to find the product embedding vector most approximate to the new product embedding vector. In a step 110, the analysis calculation device sets the model test time and the family test time of the existing product corresponding to the found product embedding vector as an estimation suggestion for a model test time and a family test time of the new product.

According to the above-mentioned contents, the difference between the present invention and the conventional technology is that, in the present invention, the database, the product configuration word database and the product embedding vector database are established, the new product configuration information is analyzed to obtain the analysis words, one-hots corresponding to the analysis words are queried and imported into the trained word2vec neural network model in sequential order to calculate the word embedding vectors, and all of the word embedding vectors are added to obtain the new product embedding vector, and the new product embedding vector is compared with the existing product embedding vectors to find the product embedding vector most approximate to the new product embedding vector, and the model test time and the family test time of the existing product corresponding to the found product embedding vector are used as the estimation suggestion for the model test time and the family test time of the new product.

According to the above-mentioned technical solution, the present invention is able to solve the conventional technology problem of inaccurate product test time estimation, so as to achieve the technical effect of providing the test time estimation suggestion based on the product configuration information.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A test time estimation suggestion providing system based on product configuration information, wherein the test time estimation suggestion providing system is adapted to an analysis calculation device and comprises:
a database configured to store an exist product family, an exist product model, a model test time and a family test time of an existing product;
a product configuration word database configured to store product configuration words and one-hots, wherein the product configuration words are generated by analyzing product configuration information of the existing product;
a product embedding vector database configured to store a product embedding vector of the existing product, and perform hierarchical clustering calculation on the product embedding vector to generate a hierarchical clustering tree with at least three layers;
a receiving module configured to receive new product configuration information of a new product;
a neural network module configured to perform word analysis on the new product configuration information to obtain a plurality of analysis words, query the product configuration word database for the one-hots corresponding to the plurality of analysis words, import the one-hots corresponding to the plurality of analysis words into a trained word2vec neural network model in sequential order to calculate a plurality of word embedding vectors, and add all of the plurality of word embedding vectors, so as to obtain a new product embedding vector of the new product configuration information; and
a time estimation module configured to compare the new product embedding vector with the hierarchical clustering tree to obtain a clustering layer, compare the new product embedding vector with the clustering layer to obtain the product embedding vector most approximate to the new product embedding vector, and use the model test time and the family test time of the existing product corresponding to the product embedding vector as an estimation suggestion for the model test time and the family test time of the new product.

2. The test time estimation suggestion providing system based on product configuration information according to claim 1, wherein the analysis calculation device performs statistics analysis on historical data of the existing product, which excludes outlier data, to calculate an average of the model test times and an average of family test times in the historical data as the model test time and the family test time stored in the database, respectively.

3. The test time estimation suggestion providing system based on product configuration information according to claim 1, wherein the analysis calculation device performs word analysis on the product configuration information of the existing product, and sets the one-hots, which are unique and non-repetitive, to the product configuration words respectively, so as to establish the product configuration word database in advance.

4. The test time estimation suggestion providing system based on product configuration information according to claim 1, wherein the analysis calculation device performs word analysis on the product configuration information through the neural network module, to obtain a set of center words and at least two environment words, query the product configuration word database for the one-hots corresponding to the set of center words and the at least two environment words, train a word2vec neural network model with the one-hots, corresponding to the at least two environment words and used as input for the word2vec neural network model, and with the one-hots corresponding to the set of center words and used as labels for the word2vec neural network model, for many times, to obtain a plurality of training embedding vectors, and then add all of the plurality of training embedding vectors to generate the product embedding vector of the product configuration information.

5. The test time estimation suggestion providing system based on product configuration information according to claim 4, wherein the neural network module performs word analysis on the product configuration information to obtain the set of center words and the at least two environment words by selecting a set number of words from the product configuration information in sequential order, using a middle part of the selected words as the set of center words and using the remaining words of the selected words as the at least two environment words, wherein the set number is odd.

6. A test time estimation suggestion providing method based on product configuration information, wherein the test time estimation suggestion providing method is adapted to an analysis calculation device and comprises:
using the analysis calculation device to establish a database in advance to store an exist product family, an exist product model, a model test time and a family test time of an existing product;
using the analysis calculation device to establish a product configuration word database in advance to store product configuration words and one-hots, wherein the product configuration words are obtained by analyzing product configuration information of the existing product;
using the analysis calculation device to establish a product embedding vector database in advance to store a product embedding vector of the existing product, and using the analysis calculation device to perform hierarchical clustering calculation on the product embedding vectors to generate a hierarchical clustering tree with at least three layers:
using the analysis calculation device to receive new product configuration information of a new product;
using the analysis calculation device to perform word analysis on the new product configuration information to obtain a plurality of analysis words;
using the analysis calculation device to query product configuration word database for the one-hot corresponding to the plurality of analysis words:
using the analysis calculation device to import the one-hots corresponding to the plurality of analysis words into the trained word2vec neural network model in sequential order, to calculate a plurality of word embedding vectors, and add of the word embedding vectors to generate a new product embedding vector of the new product configuration information;
using the analysis calculation device to compare the new product embedding vector with the hierarchical clustering tree to obtain a clustering layer;
using the analysis calculation device to compare the new product embedding vector with the clustering layer to find the product embedding vector most approximate to the new product embedding vector; and
using the analysis calculation device to set the model test time and the family test time of the existing product corresponding to the found product embedding vector as an estimation suggestion for a model test time and a family test time of the new product.

7. The test time estimation suggestion providing method based on product configuration information according to claim 6, wherein the step of using the analysis calculation device to establish the database in advance to store the exist product family, the exist product model, the model test time, and the family test time of the existing product, comprises:
performing statistics analysis on historical data of the existing product, which excludes outlier data, to calculate an average of the model test times and an average of family test times in the historical data as the model test time and the family test time stored in the database, respectively.

8. The test time estimation suggestion providing method based on product configuration information according to claim 6, wherein the step of using the analysis calculation device to establish the product configuration word database in advance to store the product configuration words and the one-hots which are obtained by analyzing the product configuration information of the existing product, comprises:
performing word analysis on the product configuration information of the existing product, and setting the one-hots, which are unique and non-repetitive, to the product configuration words respectively, so as to establish the product configuration word database in advance.

9. The test time estimation suggestion providing method based on product configuration information according to claim 6, wherein the step of using the analysis calculation device to establish the product embedding vector database in advance to store the product embedding vector of the existing product, comprises;
performing word analysis on the product configuration information to obtain a set of center words and at least two environment words;
querying the product configuration word database for the one-hots corresponding to the set of center words and the at least two environment words;
training a word2vec neural network model with the one-hots, corresponding to the at least two environment words and used as input for the word2vec neural network model, and with the one-hots corresponding to the set of center words and used as labels for the word2vec neural network model, for many times, to obtain a plurality of training embedding vectors; and
adding all of the plurality of training embedding vectors to generate the product embedding vector of the product configuration information.

10. The test time estimation suggestion providing method based on product configuration information according to claim 9, wherein the step of using the analysis calculation device to perform word analysis on the product configuration information to obtain the set of center words and the at least two environment words, comprises:
performing word analysis on the product configuration information to obtain the set of center words and the at least two environment words by selecting a set number of words from the product configuration information in sequential order; and
using a middle part of the selected words as the set of center words and using the remaining words of the selected words as the at least two environment words, wherein the set number is odd.
